(19) United States
(12) Patent Application Publication
(10) Pub. No.: US 2024/0397877 A1
(43) Pub. Date: Dec. 5, 2024

(54) SINGLE BLADE PLANT PRUNER

(71) Applicant: Chad Eric DORTON, Van Nuys, CA (US)

(72) Inventor: Chad Eric DORTON, Van Nuys, CA (US)

(21) Appl. No.: 18/800,441

(22) Filed: Aug. 12, 2024

Related U.S. Application Data
(63) Continuation-in-part of application No. 17/227,716, filed on Apr. 12, 2021.
Application No. 17/227,716 is a continuation-in-part of application No. 16/131,496, filed on Sep. 14, 2018, now abandoned.
(60) Provisional application No. 62/606,249, filed on Sep. 15, 2017.

(51) Int. Cl. A01G 3/02

(52) U.S. Cl. CPC A01G 3/02

(57) ABSTRACT

A plant pruner comprising a single blade is disclosed. The plant pruner comprises a U-shaped housing having a first arm and second arm extending from a U-shaped first end. The first arm comprises a mounting block for receiving a blade. The second arm comprising a cutting block to provide a cutting surface with the cutting edge of the blade.

### CROSS-REFERENCE TO RELATED APPLICATIONS

This application is a continuation in part application of U.S. patent application Ser. No. 17/227,716 filed Apr. 12, 2021, which is a continuation in part of application Ser. No. 16/131,496 filed Sep. 14, 2018, which claims benefit of U.S. Provisional Patent Application No. 62/606,249, filed Sep. 15, 2017. The entire contents of which are hereby incorporated by reference.

### BACKGROUND

Plants are pruned today by using scissor type cutters. Today's plant pruners function with a scissor type, double blade cutting mechanism.

When pruning with scissor type cutters, the double blade cutting mechanism smashes the stem/cellular wall of the plant. When the cellular wall of a plant is damaged it takes longer for the new shoot or new node to grow.

Another problem with pruning a plant with double blade cutting mechanism is you have to sharpen the cutter. Even having the sharpest scissor type cutter, you will still have damage to the cellular wall of the plant.

When using scissor type cutters, you must clean multiple blades to minimize the number of bacteria that is being transferred on to the plant limb.

Plant pruning is a very time consuming and tedious process which needs to remain sanitary, precise and safe throughout the process. The way plant pruning is done today is not the most effective or efficient process.

U.S. Pat. No. 5,438,759 to Dieringer, is a Button Removal Device. Although the device has the U-shaped housing, it is used to remove buttons from card stock.

U.S. Pat. No. US D485,014 S to LaMagna and Giampaoli, is a Cuticle Nipper Tweezer. The Tweezer has the U-shaped housing; however, it is designed to nip cuticles.

U.S. Pat. No. 8,984,754 B1 to Kaidi and Shamsapour, is a Nail Clipper with Blade Insert. The Nail Clipper has the U-shaped housing and removal blade, it is designed to cut finger or toenails.

U.S. Pat. No. 8,429,825 B2 to Johanson, is a Cutting Apparatus. The Cutting Apparatus has the U-shaped housing with a slot for the blade to push through to an activated position, with the cutting edge extending outwardly of the slot and guide. The Apparatus is used to cut various materials such as paperboard or corrugated paper.

U.S. Pat. No. 5,353,505 to Okada, is Grip Scissors. The Scissors have the U-shaped housing with two blades that slide past each other. The Grip Scissors are used for thread-cutting.

U.S. Pat. No. 4,092,776 to Ferguson, is a Cutting Tool. The Cutting Tool has the U-shaped housing with two blades which are able to crossover and clear said cutting surface.

U.S. Pat. No. Des. 273,172 to Yamagishi, is a Thread Nipper or The Like. The Thread Nipper has the U-shaped housing with two blades that crossover. The purpose of the Thread Nipper is thread-cutting.

U.S. Pat. No. D613,571 S to Quante, is a Cutting Implement. The Cutting Implement has the U-shaped housing with two crossover blades.

U.S. Pat. No. 5,016,353 to Iten, is a Suture Cutter. The Suture Cutter has the U-shaped housing with a blade that functions as a probe. It provides a suture cutter for cutting sutures in a skin surface.

U.S. Pat. No. 4,053,979 to Tuthill and Freeborn, is a Suture Cutter. The Suture Cutter has the U-shaped housing and removes surgical sutures with a slicing action.

U.S. Pat. No. 5,711,075 to Wolf, is a Unitarily Formed Plastic Soft Tissue Nipper. The Soft Tissue Nipper has the U-shaped housing with two blades at the end of each arm. The blades are required to be urged into abutting edge-to-edge contact. The purpose of the Soft Tissue Nipper is to be a hand-held tool for removing soft tissue, such as cuticles at base of fingernails.

U.S. Pat. No. 7,730,620 B1 to Anastasi, is a Plastic Package Opener. The Package Opener has the U-shaped housing with a blade member is mounted within the interior surface of an angled leg in order for the blade member to be directed across the surface of a plastic package.

### SUMMARY

The present invention, The Original Single Blade Plant Pruner, does not require using a scissor type cutter with two blades to prune plants. In some embodiments, a single blade mounted into the U-shaped housing that presses firmly against a flat surface. Only one blade is used, in order to remove the limb of a plant without damage. Plant pruning with the present invention is not hard on the plant and allows new nodes to reproduce immediately. The present invention prunes without the crushing of the plant limbs. The present invention allows the blade to remain sanitized which allows for a clean, precise cut. The present invention allows for you to make multiple cuts with the same precision as the first in the circumstance you made your first cut incorrectly. The present invention has an easy squeeze function which allows for easy, safe use in either hand. It allows even the novice pruner case of use.

Plant pruning is important in everyone's everyday life. Plant pruning is a huge industry. Having plants remain undamaged during the pruning phase is a huge breakthrough that will benefit the entire world. Plant pruning is important to the world because: almost all fruits and vegetables that are consumed around the world comes from a plant that has been pruned. Almost all plants, flowers and trees must be pruned to achieve high levels of produce. Being able to prune a plant without damaging the plant limb allows the plant to reproduce quickly.

In a plant pruner with a single blade cutting mechanism of the type comprising a U-shaped housing, slider, removeable single blade, and a flat cutting surface for the single blade to cut against. The plant pruner with a single blade cutting mechanism wherein said body is composed of mold injected plastic. The plant pruner with a single blade cutting mechanism of wherein said body is a U-shaped housing. The U-shaped housing wherein the top part of the U-shaped housing there is a square dado grove for the single blade to fit into. The U-shaped housing of wherein said body has a raised, flat cutting surface beneath the blade. The flat cutting surface of wherein said body is raised, the length extends the whole length of the blade and the width of the housing. The plant pruner with a single blade cutting mechanism of wherein said body houses a removeable single blade. The single blade wherein said body is a blade with an injection mold encasing the top of the blade. The injection mold of wherein the injection mold has a raised notch on one end for the slider to keep blade securely in position. The slider wherein said body is composed of injection mold. The injection mold wherein the body of the slider has a raised button on top of the slider. The slider wherein slides inside a grove in the U-shaped housing directly above the blade. The slider wherein said body has a round indentation underneath the slider which aligns with the notch on the injection mold of the single blade.

Method of using a plant pruner with single blade cutting mechanism: providing a plant pruner, providing a single blade and inserting the single blade into the plant pruner, pushing closed the slider so the single blade is securely in place, insert plant limb into plant pruner squeeze U-shaped housing closed, bringing the single blade down firmly against the flat cutting surface.

Disclosed herein are embodiments of a plant pruner. The plant pruner may comprise a U-shaped housing, a blade, and a blade slide lock. The U-shaped housing may comprise a first U-shaped end, a first arm extending from the first U-shaped end, and a second arm extending from the U-shaped end.

The first arm may include a blade mounting block having a blade groove for receiving the blade and a slider groove for receiving the blade slide lock.

The second arm may comprise a cutting block at its terminal end. The cutting edge of the blade may extend outwardly from the blade mounting block.

The blade slide lock may be disposed within the slider groove of the first arm of the U-shaped housing. The blade slide lock may slide within the slider groove into the blade mounting block secure the blade.

The second arm may further comprise a recess and the blade mounting block may contact a surface of the recess when the plant pruner is in a closed configuration. The length of the recess may approximately equal to a length of the blade mounting block and the cap when the cap is coupled to the blade mounting block.

The thickness of the first U-shaped end of the U-shaped housing may be less than the thickness of the first arm and the second arm proximal to the first U-shaped end. The thickness of the first U-shaped end of the U-shaped housing is approximately half of the thickness of the second arm at the portion of the second arm proximal to the first U-shaped end.

The angle between the first arm and the second arm may approximately 10 degrees when the plant pruner is in an open configuration. The first arm and the second arm may be approximately parallel when the plant pruner is in a closed configuration.

The blade may comprise a ledge, and mounting block may comprise a corresponding ledge, such that the ledge of the blade abuts the ledge of the cap when the blade is disposed within the blade mounting block.

The blade slide lock may comprise a nub, and the nub may protrude from a top surface of the first arm when the blade slide lock is disposed within the slider groove. The nub may comprise ridges.

The blade slide lock may comprise two bottom protrusions and a blade groove formed therebetween. A top edge of the blade may be disposed within the blade groove of the blade slide lock when the blade slide lock is positioned above the blade.

The cutting edge of the blade may be approximately equal to the length of the cutting block.

### BRIEF DESCRIPTION OF THE DRAWINGS

FIG. 1 is a side perspective illustration of the plant pruner, according to some embodiments.

FIG. 2 is a cross-sectional side perspective illustration of the plant pruner with the single blade in the closed position, according to some embodiments.

FIG. 3 is close-up cross-sectional side perspective of the plant pruner with the single blade in the closed position, according to some embodiments.

FIG. 4 is a cross-sectional side perspective illustration of the plant pruner with the single blade in the open position, according to some embodiments.

FIG. 5 is a cross-sectional side perspective illustration of the plant pruner in the open position, according to some embodiments.

FIG. 6 is an over-head perspective illustration of the plant pruner in the closed position, according to some embodiments.

FIG. 7 is an over-head perspective illustration of the plant pruner with the single blade in the open position, according to some embodiments.

FIG. 8 is an over-head perspective illustration of the plant pruner in the open position, according to some embodiments.

FIG. 9 is a side perspective illustration of the single blade of the plant pruner, according to some embodiments.

FIG. 10A is a side plan illustration of the plant pruner in an open configuration, according to some embodiments.

FIG. 10B is a side plan illustration of the plant pruner in a closed configuration, according to some embodiments.

FIG. 10C is a top plan illustration of the plant pruner, according to some embodiments.

FIG. 10D is a cross-sectional side plan illustration of the plant pruner taken along line 10D in FIG. 10C, according to some embodiments.

FIG. 11A is top plan view of a blade slide lock component of the plant pruner, according to some embodiments.

FIG. 11B is front plan view of a blade slide lock component of the plant pruner, according to some embodiments.

FIG. 12A is side plan view of a blade component of the plant pruner, according to some embodiments.

FIG. 12B is detailed view of a blade component of the plant pruner, according to some embodiments.

FIG. 12C is detailed view of a blade component of the plant pruner, according to some embodiments.

FIG. 13A is an exploded perspective illustration of the plant pruner, according to some embodiments.

FIG. 13B is a side plan illustration of the plant pruner, according to some embodiments.

FIG. 13C is a top plan illustration of the plant pruner, according to some embodiments.

FIG. 13D is a cross-sectional side plan illustration of the plant pruner taken along line 13D in FIG. 13C, according to some embodiments.

FIG. 14 is a perspective illustration of a housing component of the plant pruner, according to some embodiments.

FIG. 15A is a perspective illustration of a cap component of the plant pruner, according to some embodiments.

FIG. 15B is a perspective illustration of a cap component of the plant pruner, according to some embodiments.

### DETAILED DESCRIPTION

The invention is not necessarily limited to the examples described, which can be varied in construction and detail. As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g., “about 90%” may refer to the range of values from 71% to 99%.

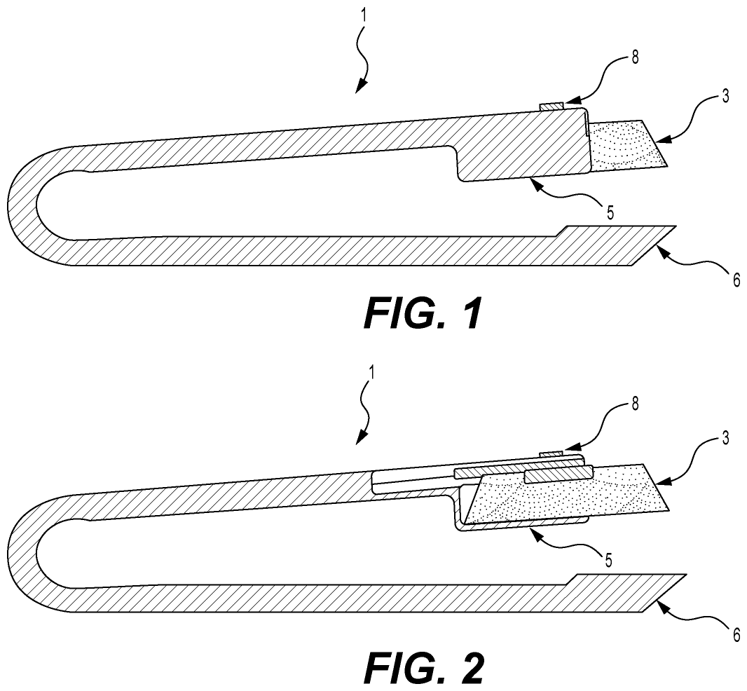

FIG. 1 illustrates the present invention of the U-shaped housing 4, blade mounting block 5, and spacer-flat surface 6 are all one piece, according to some embodiments. A single blade 3 is used because a cutting needs to have one clean, precise cut. The single blade 3 is positioned from front to back, to provide the best angle to cut. It is important to only have one blade as having more than one blade to make a cutting, damages the fibers at the end of the cutting. In some embodiments, the U-shaped housing 4 was facilitates easy cleaning of the tool, having bacteria get onto to surface of the tool would contaminate the cutting. The U-shaped housing 4 is also used for ease of squeezing the tool with one free hand. The blade mounting block 5 is used to angle the U-shaped housing 4 to the angle the single blade 3 closes on the spacer-flat surface 6.

FIG. 2 illustrates a cross-sectional side perspective of the present invention with the single blade in the closed position. The U-shaped housing 4, blade mounting block 5, and spacer-flat surface 6 are all one piece. The single blade 3 has a blade mount 9. The blade mount 9 of the single blade 3 sits in a square groove of the blade mounting block 5 of the U-shaped housing 4. The blade slide lock 7 slides back and forth on a slider groove. The blade slide lock 7 keeps the single blade 3 securely in place and slides back and forth for easy removal of the single blade 3. The slider nub 8 is in place to allow easy control of the blade slide lock 7.

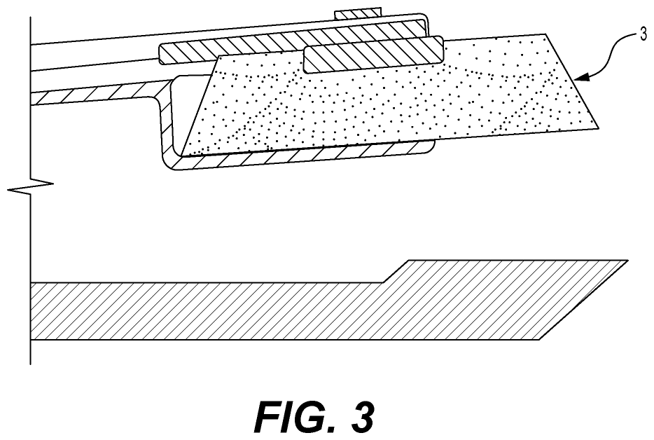

FIG. 3 illustrates a close-up cross-sectional side perspective of the present invention with the single blade in the closed position. The U-shaped housing 4, blade mounting block 5, and spacer-flat surface 6 are all one piece. The single blade 3 has a blade mount 9. The blade mount 9 of the single blade 3 sits in a square groove of the blade mounting block 5 of the U-shaped housing 4. The blade slide lock 7 slides back and forth on a slider groove. The blade slide lock 7 is in the closed position securing the single blade 3 in place. The slider nub 8 is in place to allow easy control of the blade slide lock 7.

FIG. 4 illustrates a cross-sectional side perspective of the present invention with the single blade in the open position. The U-shaped housing 4, blade mounting block 5, and spacer-flat surface 6 are all one piece. The single blade 3 has a blade mount 9. The blade mount 9 of the single blade 3 sits in a square groove of the blade mounting block 5 of the U-shaped housing 4. The blade slide lock 7 slides back and forth on a slider groove. The blade slide lock 7 is in the open position allowing easy removal of the single blade 3. The slider nub 8 is in place to allow easy control of the blade slide lock 7.

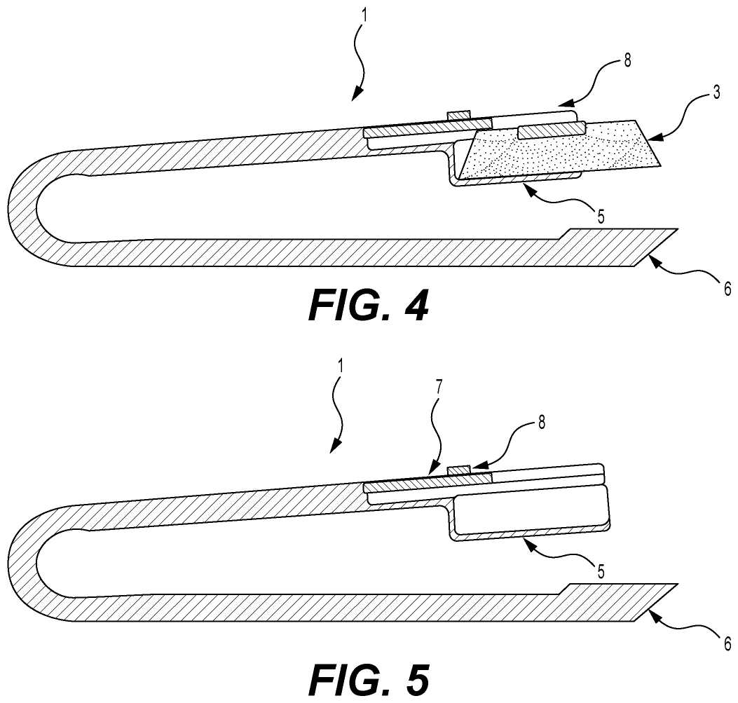

FIG. 5 illustrates a cross-sectional side perspective of the present invention in the open position. The U-shaped housing 4, blade mounting block 5, and spacer-flat surface 6 are all one piece. The blade slide lock 7 slides back and forth on a slider groove. The slider nub 8 is in place to allow easy control of the blade slide lock 7.

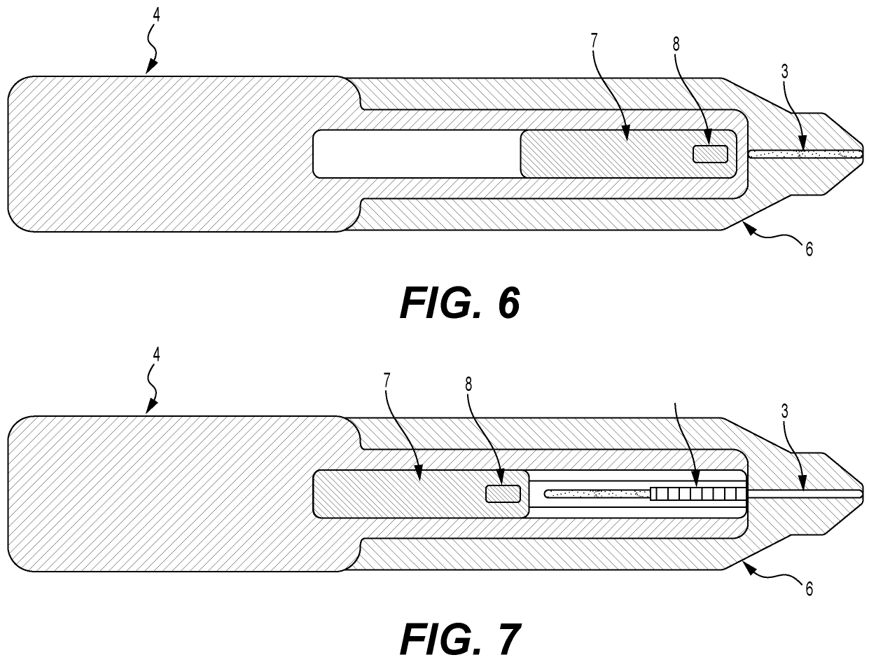

FIG. 6 is an over-head perspective illustration of the present invention in the closed position. The U-shaped housing 4 is one piece wherein the blade slide lock 7 has a raised slider nub 8 on top of the slider. The blade slide lock 7 slides inside a slider groove in the U-shaped housing 4 directly above the single blade 3. The blade slide lock 7 has a round indentation that aligns with the single blade 3.

FIG. 7 is an over-head perspective illustration of the present invention with the single blade in the open position. The U-shaped housing 4 is one piece wherein the blade slide lock 7 has a raised slider nub 8 on top of the slide lock. The blade slide lock 7 slides inside a slider groove in the U-shaped housing 4 directly above the single blade 3. The blade slide lock 7 has a round indentation that aligns with the blade mount 9 of the single blade 3.

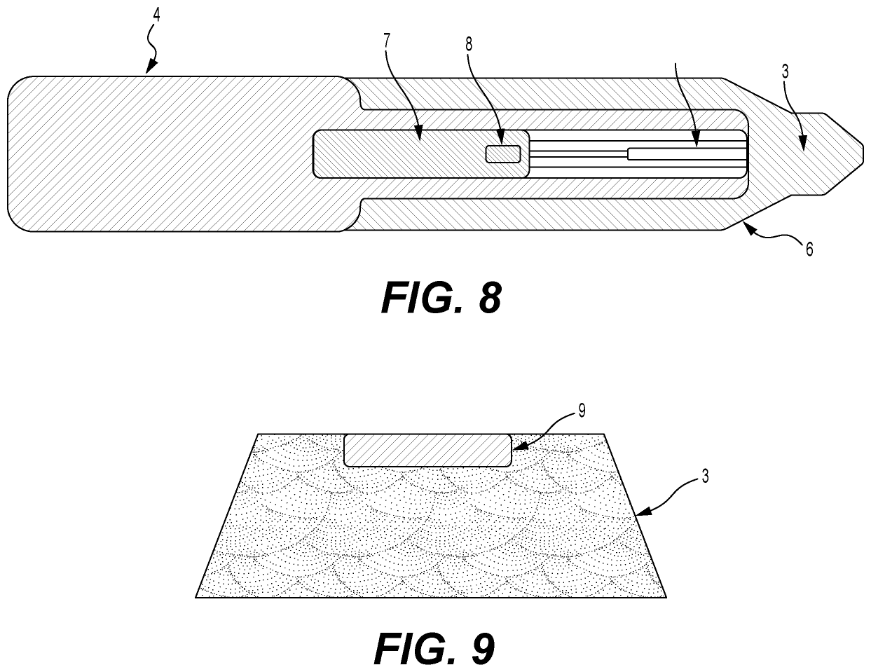

FIG. 8 is an over-head perspective illustration of the present invention in the open position. The U-shaped housing 4 is one piece wherein the blade slide lock 7 has a raised slider nub 8 on top of the slider.

FIG. 9 illustrates the blade mount 9 on the single blade 3 that enables the single blade 3 to sit in the blade mounting block 5.

Alternative blade angles can be used. Alternative angles would be to insert the blade at a 45-degree angle or straight across. However, the blade will work at these angles the best angle is front to back.

A stop can be mounted in the center, front half of the U-shaped housing to prevent someone from over squeezing the pruner.

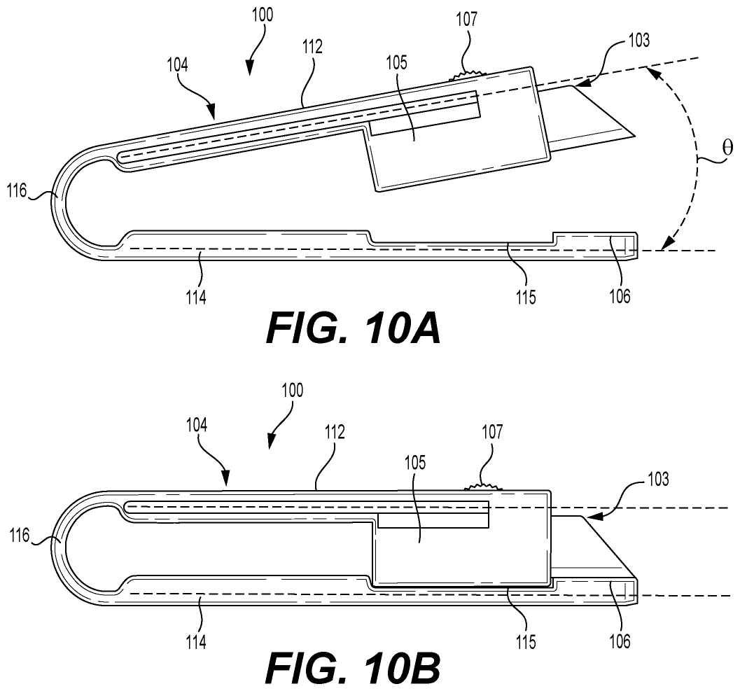

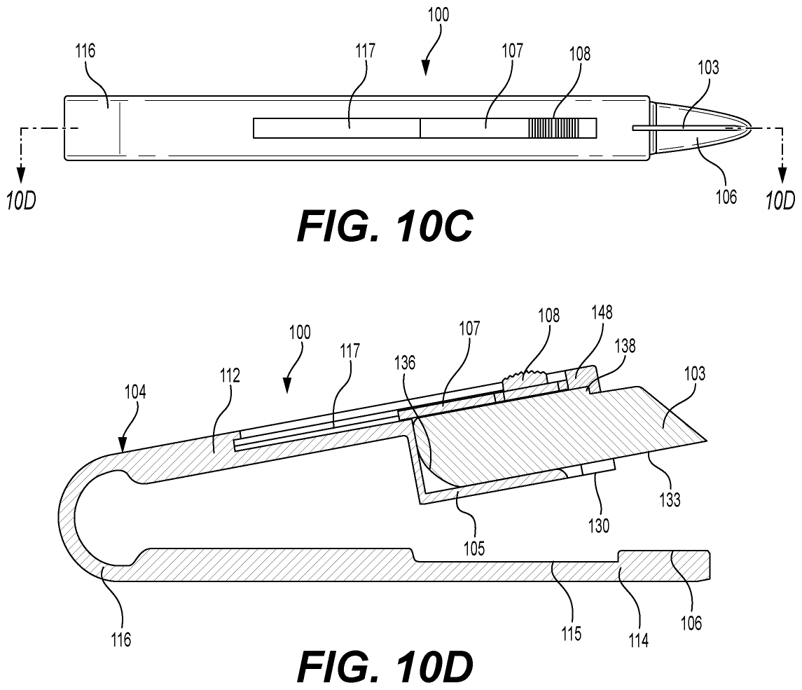

FIGS. 10A to 10D depict a plant pruner 100, according to some embodiments. In some embodiments, the plant pruner 100 comprises a housing 104. The housing 104 may also be referred to as a handle. The housing 104 may be substantially U-shaped having a first arm 112 and a second arm 114 extending from a U-shaped first end 116. The first arm 112 may terminate at the blade mounting block 105. The blade mounting block 105 is configured to removably receive a blade 103. In some embodiments, the plant pruner 100 further comprises a blade slide lock 107 for securing the blade 103 within the blade mounting block 105. The blade slide lock 107 may also be referred to as the slider herein.

In some embodiments, the blade 103 comprises an upper ledge 138 which contacts a corresponding ledge 148 provided on an inner surface of the blade mounting block 105 to secure the blade 103 within the blade mounting block 105.

In some embodiments, the blade slide lock 107 is received by a slider groove 117 provided in the first arm 112 of the housing 105. The blade slide lock 107 may be pushed to a rear position towards the first end 116 of the housing and the blade 103 may then be inserted into the blade mounting block 105. The blade slide lock 107 may then be moved toward the terminal end and into the blade mounting block 105 to be positioned above and secure the blade 103.

In some embodiments, when secured within the mounting block 105, the blade 103 extends outward from blade mounting block 105. In some embodiments, the second arm 114 of the housing 104 terminates at a flat cutting surface or cutting block 106. As depicted in FIG. 10B, during cutting of a plant limb, a user may squeeze the first arm 112 and second arm 114 together, closing the pruner and moving the blade 103 toward the cutting block 106. The first/U-shaped end 116 of the housing 104 may comprise a thinner or tapered thickness relative to the first arm 112 and the second arm 114 to facilitate closing of the pruner 100.

In some embodiments, the terminal end of the mounting block comprises a blade slit 130. In some embodiments, the blade slit 130 extends along the bottom surface of the blade mounting block, as depicted in FIG. 10D. In some embodiments, to insert the blade 103, the blade slide lock 107 is pushed back toward the U-shaped first end 116 of the housing. The blade 103 may then be inserted with the blade angled such that second end 136 of the blade 103 is provided through the slider groove 117 and the cutting edge 133 is rotated downward and provided through the blade slit 130 at the bottom of the blade mounting block 105. The blade 103 may then be rotated within the mounting block 105 to be approximately parallel with the first arm 112. The blade slide lock 107 may then be pushed forward toward into the blade mounting block and over the blade 103 to secure the blade 103 in place. To remove the blade 103, the blade slide lock 107 may be pushed back toward the U-shaped first end 116. Then the blade 103 may be rotated downward, such that the second end 136 of the blade 103 extends through the slider groove 117, and the blade may then be removed from the blade mounting block 105.

In some embodiments, the depth of the recess 115 is substantially equal to the thickness of the blade mounting block 105 which protrudes below the blade 103. The arrangement is such that the bottom of the blade mounting block contacts a top surface of the second arm 114 within the recess 115 when cutting edge 133 of the blade 103 contacts the cutting block 106, as depicted in FIG. 10B. In some embodiments, the length of the recess is approximately equal to the length of the bottom surface of the blade mounting block 105. This arrangement may provide a stop mechanism between the bottom surface of the blade mounting block 105 and top surface of the recess 115 of the second arm 114 to prevent over squeezing of the housing 104 during cutting.

As discussed above, the housing 104 may comprise a U-shaped body with two arms 112, 114 joined by a U-shaped first end 116. In some embodiments, housing 104 is a single integral piece. In some embodiments, the housing comprises fiberglass, plastic, ABS plastic, PVC Plastic, SCH 40 PVC, SCH 80 PVC Plastic, steel, stainless steel, hardened steel, spring steel, aluminum, or metal. The U-shaped first end 116 of the housing 104 may comprise a tapering/thinner thickness relative to the first arm 112 and second arm 114 to facilitate flexing/bending at the first end 116 to allow closing of the housing 104 as the first arm 112 and second arm 114 are moved towards one another to perform a cutting operation.

In some embodiments, the second arm 114 comprises a flat surface forming a cutting block 106 that the blade cuts against. The cutting block 106 may be is raised relative to the recess 115. The cutting block 106 may be parallel to a length of the second arm 114 proximal to the U-shaped first end 116. The width of the end of the second arm 114 may taper inward to a point or rounded point.

In some embodiments, a blade mounting block 105 is provided at the end of the first arm 112 and is configured for receiving a blade. The mounting block 105 may comprise a blade groove 130 or slit extending through the front surface (i.e., the terminal end of the first arm 112 opposite of the U-shaped first end 116) for receiving the blade. In some embodiments, the blade slit 130 extends through a portion of the bottom surface of the blade mounting block 105. In some embodiments, the blade slit 130 extends through a portion of the top surface of the blade mounting block 105. In some embodiments, the rear portion (i.e., the surface of the mounting block closest to the U-shaped first end 116 of the housing) do not comprise a groove, slit, or through hole such that the blade does not slide out from the mounting block.

In some embodiments, the housing 104 comprises a slider groove 117 to receive the blade slide lock 107. The blade groove 130 may extend vertically into the slider groove 117, such that a second end 136 (opposite the cutting end 133) of the blade 103 is provided into the slider groove 117 when a blade is being inserted or removed from the blade mounting block 105. The housing 104 may further comprise a cutout 118. The cutout 118 may allow a user to view the positioning of the blade slide lock 107 within the slider groove 117. The cutout 118 may also reduce the weight of the housing 104.

In some embodiments, the blade mounting block 105 of the housing 104 comprises a window 132. The window 132 may allow a user to see into the blade mounting block 105 to check for proper alignment of the blade.

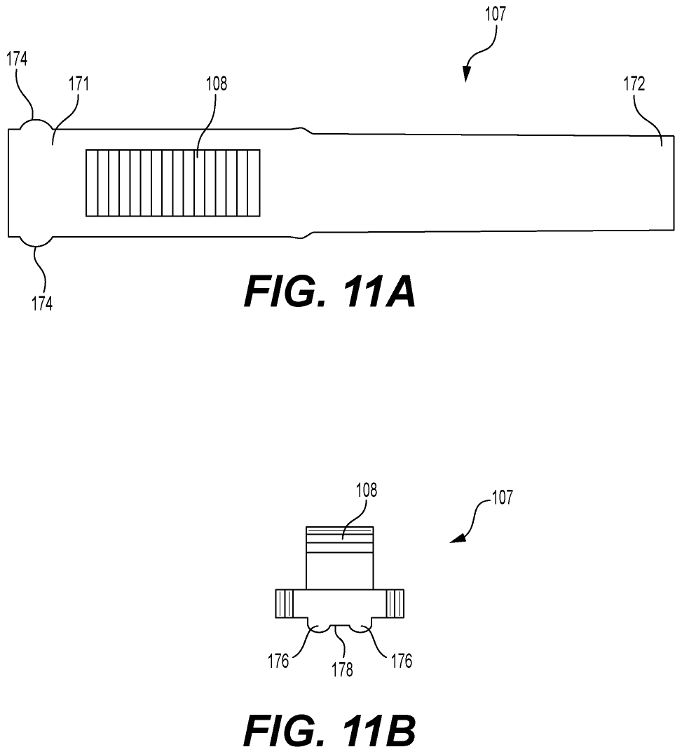

With reference to FIGS. 11A and 11B, a blade slide lock 107 is depicted, according to some embodiments. In some embodiments, the blade slide lock 107 is received by a slider groove provided within the first arm of the housing (e.g., slider groove 117 depicted in FIG. 11). The slider groove 117 of the housing is dimensioned to compliment the blade slide lock 107. In some embodiments, the blade slide lock 107 comprises a nub 108. In some embodiments, the slide groove extends through a top surface of the first arm to form an opening which allows the nub 108 of the blade slide lock to protrude above the top surface of the first arm (as depicted in FIGS. 10A-10D). The nub 108 may comprise ridges to provide grip for a user.

The blade slide lock 107 may further comprise bottom protrusions 176 extending from a bottom surface of the blade slide lock 107 and a blade groove 178 formed between the bottom protrusions 176. When a blade is mounted into the mounting block of the housing, the slide lock 107 may be slid over the blade (e.g., as depicted in FIG. 10D) and the top of the blade may fit into the blade groove 178 to secure the blade within the mounting block. The slider groove of the housing may comprise a bottom cutout to compliment the bottom protrusions 176 of the blade slide lock.

In some embodiments, a first end 171 of the blade slide lock 107 comprises protrusions 173. A middle portion of the slider groove of the housing may comprise complimentary recesses which the protrusions 174 fit into to secure the slide lock 107 in a position directly above the blade. The middle portion of the slider groove of the housing may be sized to provide a friction fit with protrusions 174 of the slide lock 107 to provide resistance until the position directly above the blade is reached by the slide lock. In some embodiments, a second end 172 of the slide lock 107 is narrower than the first end, such that friction forces are concentrated towards the slider nub 108.

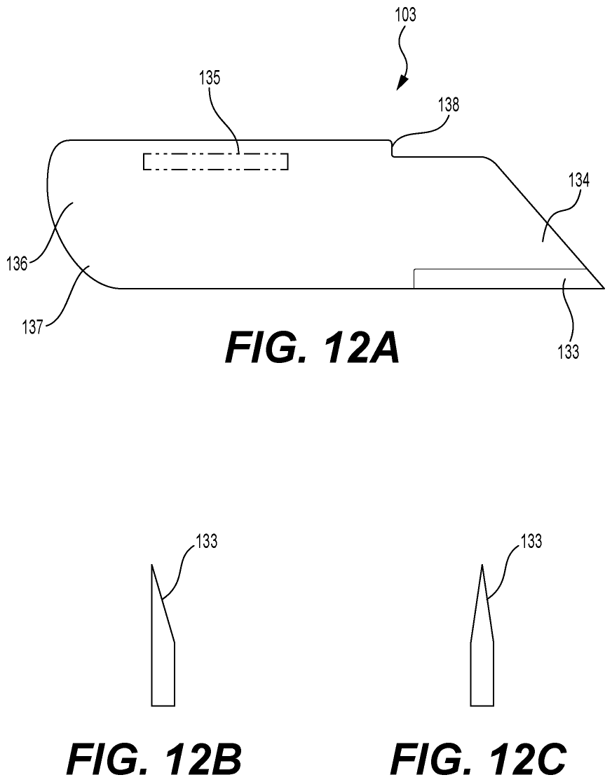

With reference to FIG. 12A, a blade 103 to be used with the plant pruner is depicted, according to some embodiments. In some embodiments, the blade 103 comprises a cutting edge 133. The cutting edge may be provided on only a portion of a bottom edge of the blade 103 at a first end of the blade. The blade 103 may further comprise a ledge 138. In some embodiments, the ledge 138 of the blade abuts an interior surface blade mounting block 105 (e.g., complimentary ledge 148 depicted in FIG. 10D), when the blade is provided within the mounting block.

The second end 136 of the blade 103 may comprise a radius 137. The radius may facilitate removal of the blade 103 from the mounting block by allowing a slight rotation (e.g., rotating the first end 134 of the blade away from the cutting block of the housing) of the blade 103 within the mounting block. In some embodiments, the blade 103 further comprises a blade mount 135. In some embodiments the blade groove of the blade mounting block further comprises a horizontal grove running perpendicular to the blade groove to receive the blade mount 135.

As depicted in FIGS. 12B and 12C, the cutting edge of the blade may be single-sided or double-sided. In some embodiments, the cutting edge of the blade comprises an angle of approximately 15 degrees.

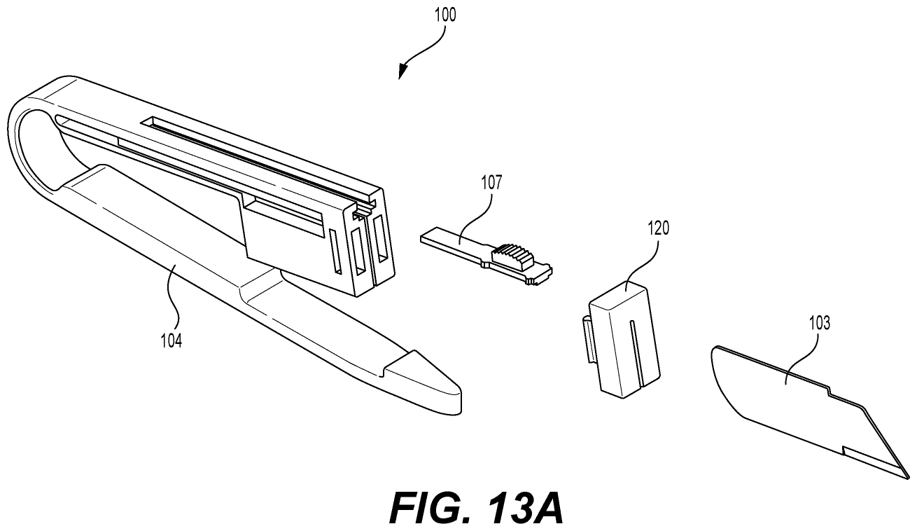

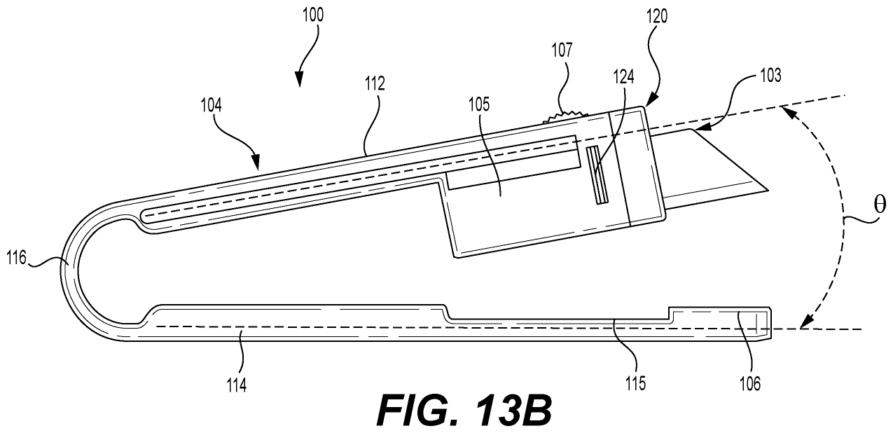

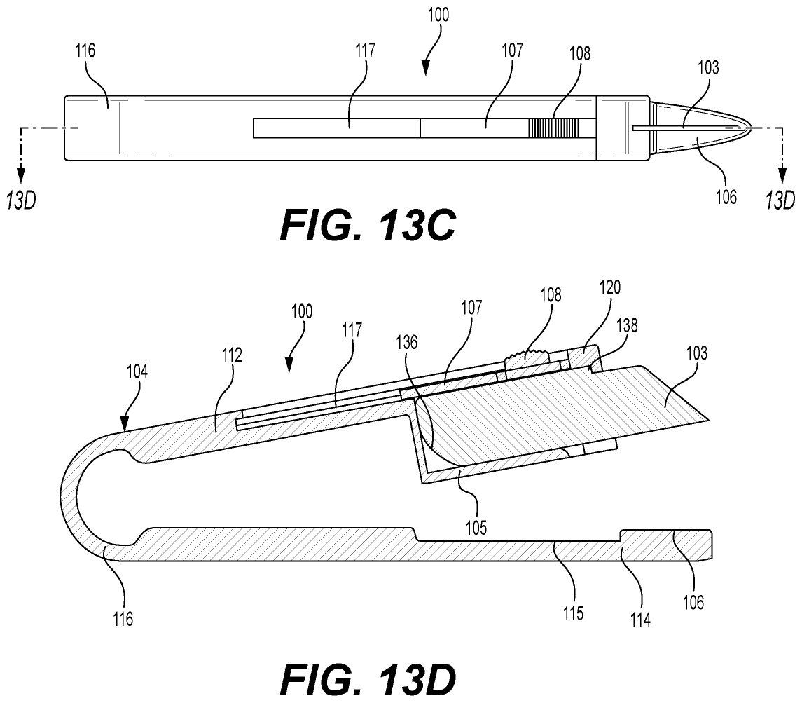

With reference to FIGS. 13A-13D, plant pruner 100 is depicted according to some embodiments. In some embodiments, the blade mounting block 105 may be configured to receive a cap 120. The cap 120 may be removably attached to the end of the blade mounting block. In some embodiments, the blade 103 comprises an upper ledge 138 which contacts an inner face of the cap 120 to secure the blade 103 within the blade mounting block 105.

In some embodiments, when secured within the mounting block 105, the blade 103 extends outward from the cap 120. In some embodiments, a cutting edge of the blade (e.g., 133, as depicted in FIG. 12A) extends from the cap 120. In some embodiments, the blade 103 is first inserted into the blade mounting block 105, then the cap 120 is coupled to the mounting block 105, and the blade slide lock 107 is pushed forward toward the cap 120 to secure the blade 103 in place.

In some embodiments, the length of the recess 115 is approximately equal to the length of the bottom surface of the blade mounting block 105 with the cap 120 attached.

In some embodiments, attachment of the cap to the end of the mounting block keeps the blade slide lock from being removed from the housing. In some embodiments, the blade slit of the cap comprises a complimentary ledge to abut the ledge 138 of the blade, as depicted in FIG. 13D).

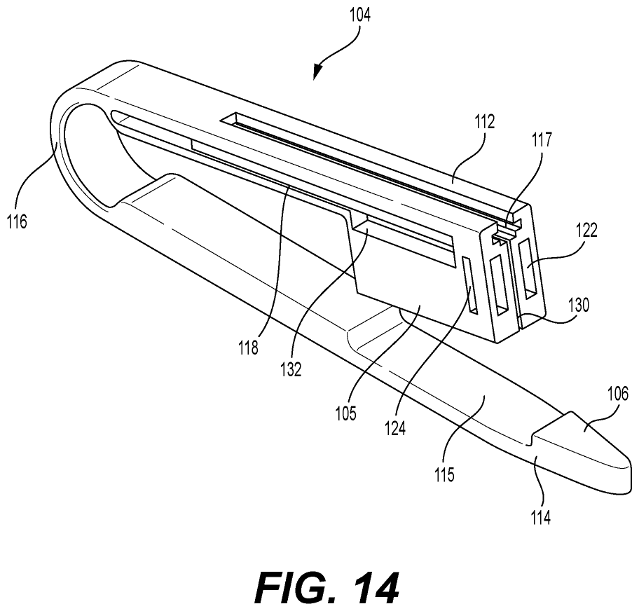

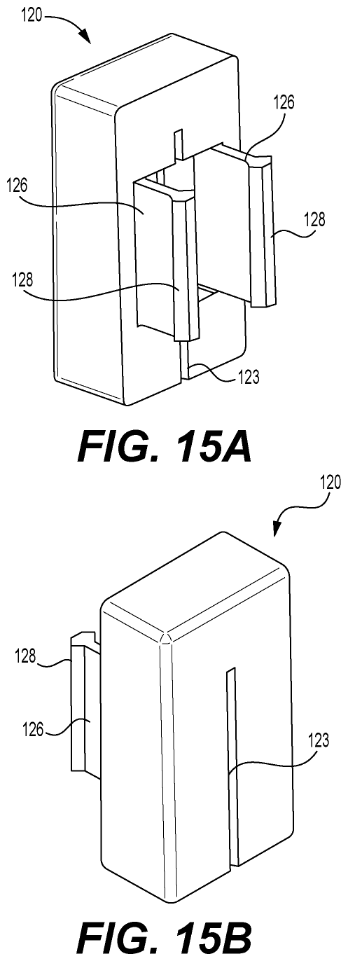

With reference to FIG. 14, in some embodiments, the blade mounting block 105 further comprises apertures 122 at the terminal end of the first arm 112 for receiving protrusions extending from the body of a cap for securing a blade within the mounting block (e.g., cap 120 having protrusions 126 extending from the cap body as depicted in FIGS. 15A and 15B). In some embodiments, the mounting block 105 further comprises openings 124 positioned on each side of the mounting block 105 configured to receive projections extending outwardly from the protrusions of the cap (e.g., projections 128 as depicted in FIGS. 15A and 15B). The openings 124 may allow for a user to compress the projections inwards, allowing for removal of the cap from the mounting block.

FIGS. 15A and 15B depict a cap 120, according to some embodiments. The cap 120 may comprise a blade slit or blade groove 123. As depicted in FIGS. 13A-13D, when the blade 103 is received by the mounting block 105 and the cap 120 is coupled to the mounting block 105, the cutting edge (e.g., cutting edge 133 depicted in FIG. 14A) extends from through the blade slit 123 and outwardly from the cap 120.

Turning back to FIGS. 15A and 15B, the cap 120 may comprise protrusions 126 on either side of the blade slit 123. The blade slit 123 may be provided through the bottom portion of the cap 120 to facilitate removal of a blade from the blade mounting block without needing to remove the cap. The ends of the protrusions 126 may comprise projections 128 which extend outwardly from the ends of the protrusions. In some embodiments, when the cap 120 is coupled to the mounting block 105, the protrusions 126 extend into apertures 122 provided at the terminal end of the mounting block. The projections 128 are then received by openings 124 provided in the mounting block 105. The arrangement may be such that when coupling the cap 120 to the mounting block 105, the protrusions 126 flex inwardly toward the blade slit 123 and then flex back to a natural state as the projections are aligned within the openings 124 on the sides of the mounting block 105.

In an exemplary embodiment, the length of the housing 104, measured from the first U-shaped end 116 of the housing to either the tip of the second arm 114 or the tip of a blade 103 mounted in the housing, is approximately 7.4 inches. In some embodiments, the width of the housing 104 is approximately 0.68 inches. The thickness of the first arm 112 of the housing 104 (excluding the mounting block 105) may be approximately 0.39 inches. In some embodiments, the thickness of the second arm 114 (excluding recess 115) is approximately equal to the thickness of the first arm. In some embodiments, the thickness of the second arm is approximately 0.36 inches. The thickness at the recess of the second arm may be approximately 0.23 inches, such that the recess sits about 0.13 inches below the cutting block 106 and surrounding portions of the second arm.

The U-shaped first end 116 of the housing 104 may taper down to a thickness of approximately 0.18 inches. When in a relaxed state or open configuration (as depicted in FIG. 10A), the first arm 112 and the second arm 114 may form an angle θ of approximately 10 degrees. When cutting, as the blade 103 engages the cutting block 106 in a closed configuration (as depicted in FIG. 10B), the first arm 112 and the second arm 114 may be approximately parallel to one another.

In an exemplary embodiment, the length of the blade 103 is approximately 3.3 inches, and the cutting edge 133 of the blade is approximately 1.1 inches. In some embodiments, the cutting edge 133 begins where the blade 103 extends from the blade mounting block 105 when mounted in the housing 104. In some embodiments, the cutting block 106 is approximately 1.1 inches long.

What is claimed is:

1. A plant pruner comprising:
a U-shaped housing comprising:
a first U-shaped end;
a first arm extending from the first U-shaped end, the first arm comprising:
a blade mounting block having a blade groove, and
and a slider groove; and
a second arm extending from the first U-shaped end, the second arm comprising a terminal end and a cutting block at the terminal end;
a blade removable disposed within the blade mounting block, wherein a cutting edge of the blade extends outwardly from blade mounting block; and
a blade slide lock disposed within the slider groove of the first arm of the U-shaped housing, the blade slide lock slides within the slider groove into the blade mounting block to secure the blade.

2. The plant pruner of claim 1, wherein the second arm further comprises a recess wherein the blade mounting block contacts a surface of the recess when the plant pruner is in a closed configuration.

3. The plant pruner of claim 2, wherein a length of the recess is approximately equal to a length of the blade mounting block.

4. The plant pruner of claim 1, wherein a thickness of the first U-shaped end of the U-shaped housing is less than a thickness of the first arm at a portion of the first arm proximal to the first U-shaped end, and the thickness of the first U-shaped end of the U-shaped housing is less than a thickness of the second arm at a portion of the second arm proximal to the first U-shaped end.

5. The plant pruner of claim 4, wherein the thickness of the first U-shaped end of the U-shaped housing is approximately half of the thickness of the second arm at the portion of the second arm proximal to the first U-shaped end.

6. The plant pruner of claim 1, wherein an angle between the first arm and the second arm is approximately 10 degrees when the plant pruner is in an open configuration.

7. The plant pruner of claim 6, wherein the first arm and the second arm are approximately parallel when the plant pruner is in a closed configuration.

8. The plant pruner of claim 1, wherein the blade comprises a ledge, and wherein the mounting block comprises a ledge corresponding to the ledge of the blade, wherein the ledge of the blade abuts the ledge the mounting block when the blade is disposed within the blade mounting block.

9. The plant pruner of claim 1, wherein the blade slide lock comprises a nub, and wherein the nub protrudes from a top surface of the first arm when the blade slide lock is disposed within the slider groove.

10. The plant pruner of claim 9, wherein the nub comprises ridges.

11. The plant pruner of claim 1, wherein the blade slide lock comprises two bottom protrusions and a blade groove formed therebetween.

12. The plant pruner of claim 11, wherein a top edge of the blade is disposed within the blade groove of the blade slide lock when the blade slide lock is positioned above the blade.

13. The plant pruner of claim 1, wherein the cutting edge of the blade is approximately equal to a length of the cutting block.
